(19) United States
(12) Patent Application Publication
(10) Pub. No.: US 2026/0228449 A1
(43) Pub. Date: Aug. 6, 2026

(54) AUTOMATED AUDIT RESPONSE GENERATION

(71) Applicant: Capital One Services, LLC, McLean, VA (US)

(72) Inventors: Grant Michael IWAN, Montpelier, VA (US); Shannon REID, Richmond, VA (US)

(21) Appl. No.: 19/047,306

(22) Filed: Feb. 6, 2025

(51) Int. Cl. G06F 40/40

(52) U.S. Cl. CPC G06F 40/40

(57) ABSTRACT

In some implementations, a response system may receive, from a user device, at least one file encoding the audit request. The audit request may be represented by a first set of text in the at least one file. The response system may provide the first set of text to a large language model, trained on a set of previous audit requests and previous responses, in order to receive the draft response. The draft response may be represented by a second set of text. The response system may generate at least one file encoding the draft response by inserting the second set of text into a template. The response system may output, to the user device, the at least one file encoding the draft response.

### BACKGROUND

Large language models (LLMs) are growing in popularity. LLMs use tokenization to accept natural language inputs and produce natural language outputs. However, LLMs are computationally intensive to train and to execute.

### SUMMARY

Some implementations described herein relate to a system for generating a draft response and retrieving a set of supporting documents in response to an audit request. The system may include one or more memories and one or more processors communicatively coupled to the one or more memories. The one or more processors may be configured to receive at least one file encoding the audit request, wherein the audit request is represented by a first set of text in the at least one file. The one or more processors may be configured to provide the first set of text to an LLM, trained on a set of previous audit requests and a set of previous responses, in order to receive the draft response, wherein the draft response is represented by a second set of text. The one or more processors may be configured to generate at least one file encoding the draft response by inserting the second set of text into a template. The one or more processors may be configured to map a portion of the second set of text to the set of supporting documents, wherein the set of supporting documents are indexed according to keywords. The one or more processors may be configured to output the at least one file encoding the draft response with an indication of the set of supporting documents.

Some implementations described herein relate to a method of generating a draft response based on an audit request. The method may include receiving, from a user device and at a response system, at least one file encoding the audit request, wherein the audit request is represented by a first set of text in the at least one file. The method may include providing the first set of text to an LLM, trained on a set of previous audit requests and previous responses, in order to receive the draft response, wherein the draft response is represented by a second set of text. The method may include generating, by the response system, at least one file encoding the draft response by inserting the second set of text into a template. The method may include outputting, to the user device and from the response system, the at least one file encoding the draft response.

Some implementations described herein relate to a non-transitory computer-readable medium that stores a set of instructions for requesting a draft response and a set of supporting documents in response to an audit request. The set of instructions, when executed by one or more processors of a device, may cause the device to transmit at least one file encoding the audit request, wherein the audit request is represented by a first set of text in the at least one file. The set of instructions, when executed by one or more processors of the device, may cause the device to receive, in response to the at least one file encoding the audit request, at least one file encoding the draft response, wherein the draft response is represented by a second set of text, and wherein the second set of text is provided by an LLM based on the first set of text. The set of instructions, when executed by one or more processors of the device, may cause the device to receive, in response to the at least one file encoding the audit request, an indication of the set of supporting documents, wherein the set of supporting documents are stored in a storage system accessible by the device.

### BRIEF DESCRIPTION OF THE DRAWINGS

FIGS. 1A-1C are diagrams of an example implementation relating to automated audit response generation, in accordance with some embodiments of the present disclosure.

FIGS. 2A-2B are diagrams of an example implementation relating to applying an LLM, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-6 are flowcharts of example processes relating to automated audit response generation, in accordance with some embodiments of the present disclosure.

### DETAILED DESCRIPTION

The following detailed description of example implementations refers to the accompanying drawings. The same reference numbers in different drawings may identify the same or similar elements.

LLMs use tokenization to accept natural language inputs and produce natural language outputs. For example, LLMs may use a generative pre-trained transformer (GPT) neural network, which uses a transformer deep learning architecture that is pre-trained on large data sets of unlabeled text. However, general-purpose LLMs are computationally intensive to train and to execute. Therefore, refinement to improve accuracy is costlier as compared with smaller and more efficient neural network architectures.

Deploying an LLM to generate a response to an audit request may improve speed of generating the response as compared with other machine learning models. However, the LLM may be computationally expensive to train and run. Additionally, the LLM may, depending on how the LLM is trained, hallucinate supporting documents for the response rather than identifying real supporting documents to use.

Some implementations described herein enable an LLM, trained on a set of previous audit requests and previous responses, to generate a response to an audit request. Additionally, the response from the LLM may be inserted into a template in order to ensure proper formatting. As a result, the LLM may be faster than other machine learning models at generating the response, and allowing the LLM to ignore formatting (because the template will handle formatting) conserves computing resources as compared with trying to prompt the LLM to engage in proper formatting. Additionally, or alternatively, some implementations described herein enable the LLM to cooperate with a keyword-based machine learning model. For example, the keyword-based machine learning model may retrieve supporting documents based on the response generated by the LLM. Because the keyword-based machine learning model is more lightweight than neuron-heavy models like the LLM, the keyword-based machine learning model may reduce computational cost. Additionally, the keyword-based machine learning model improves accuracy by avoiding risk of hallucinating supporting documents.

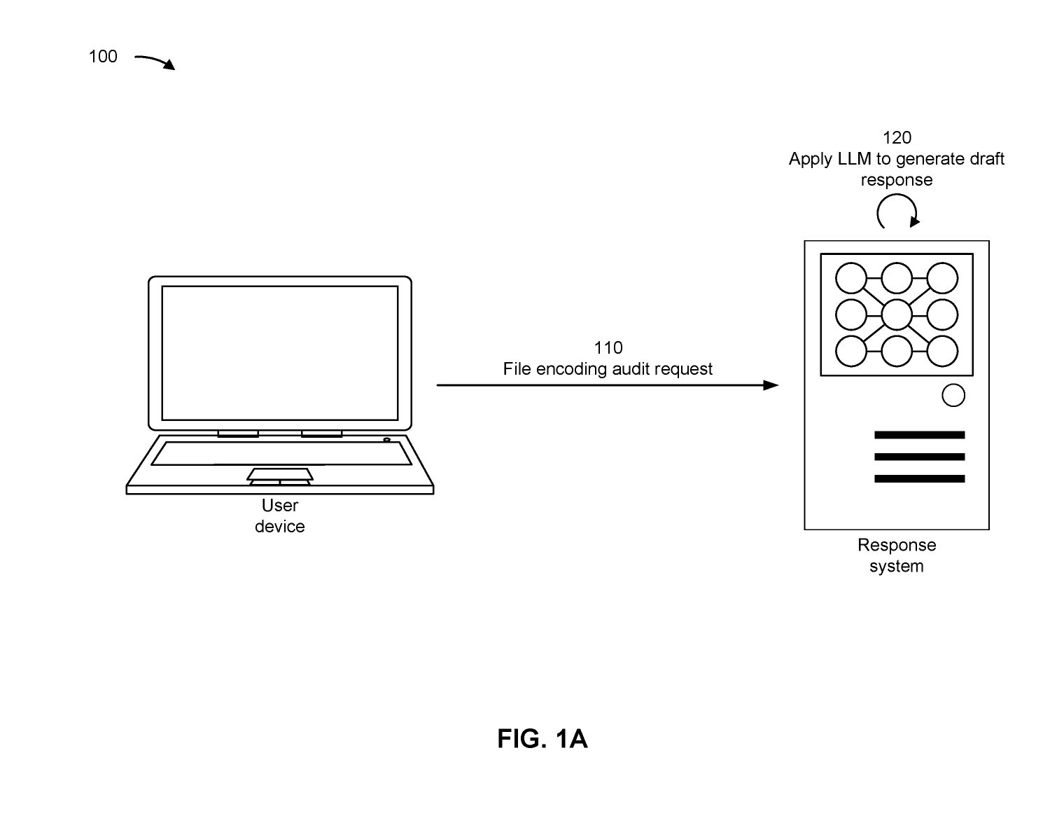

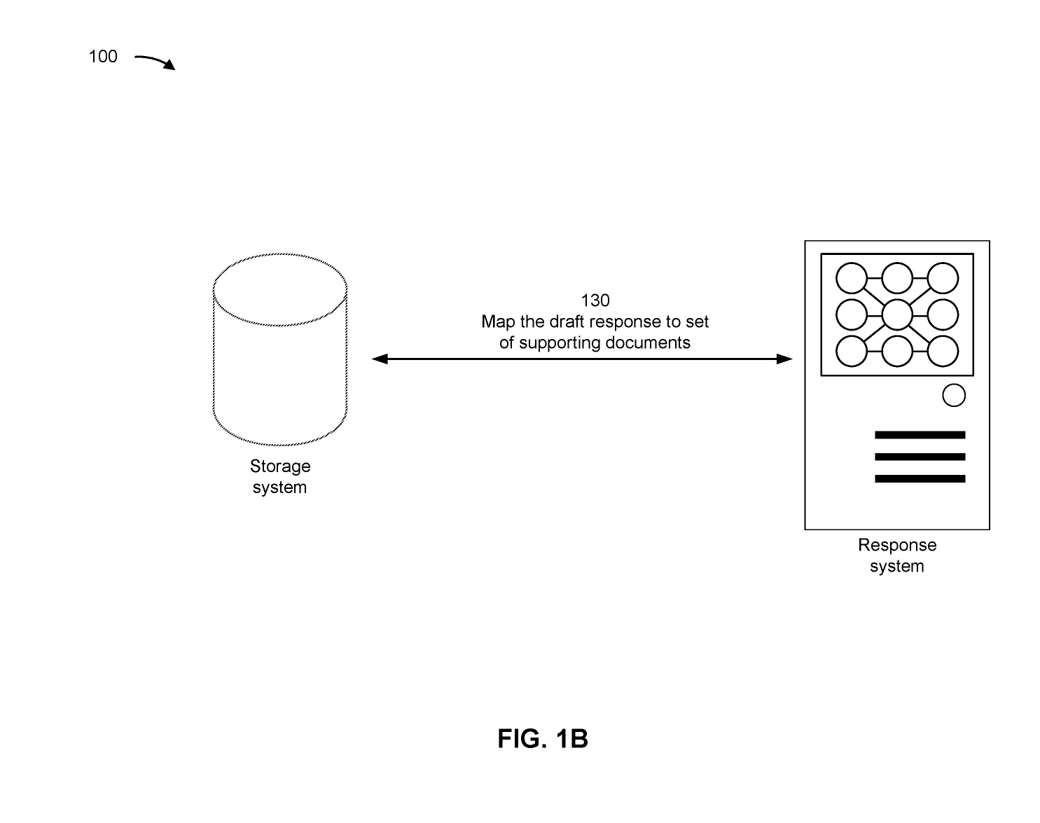

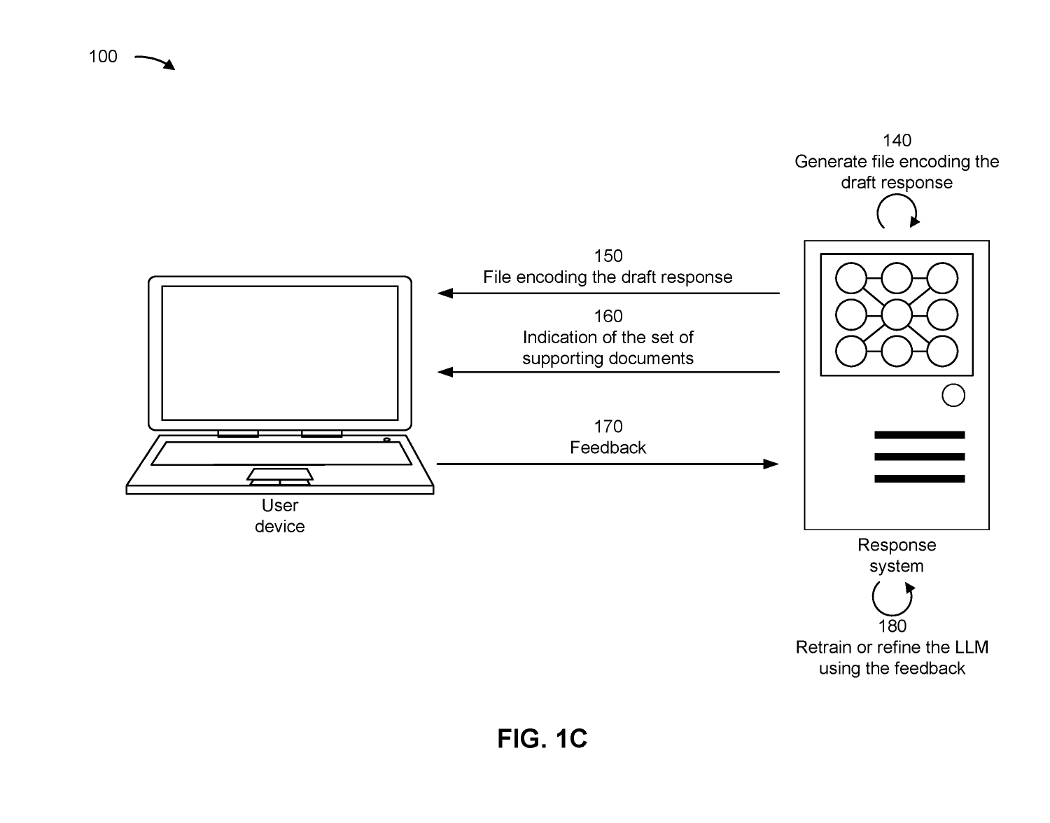

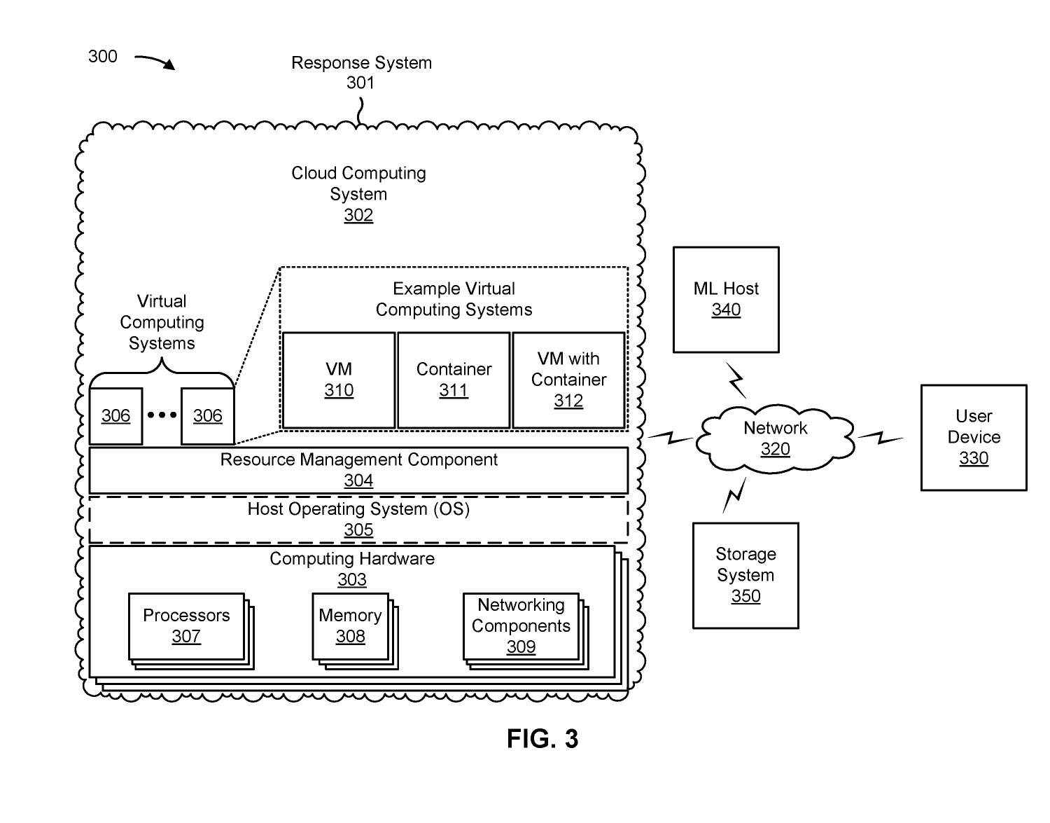

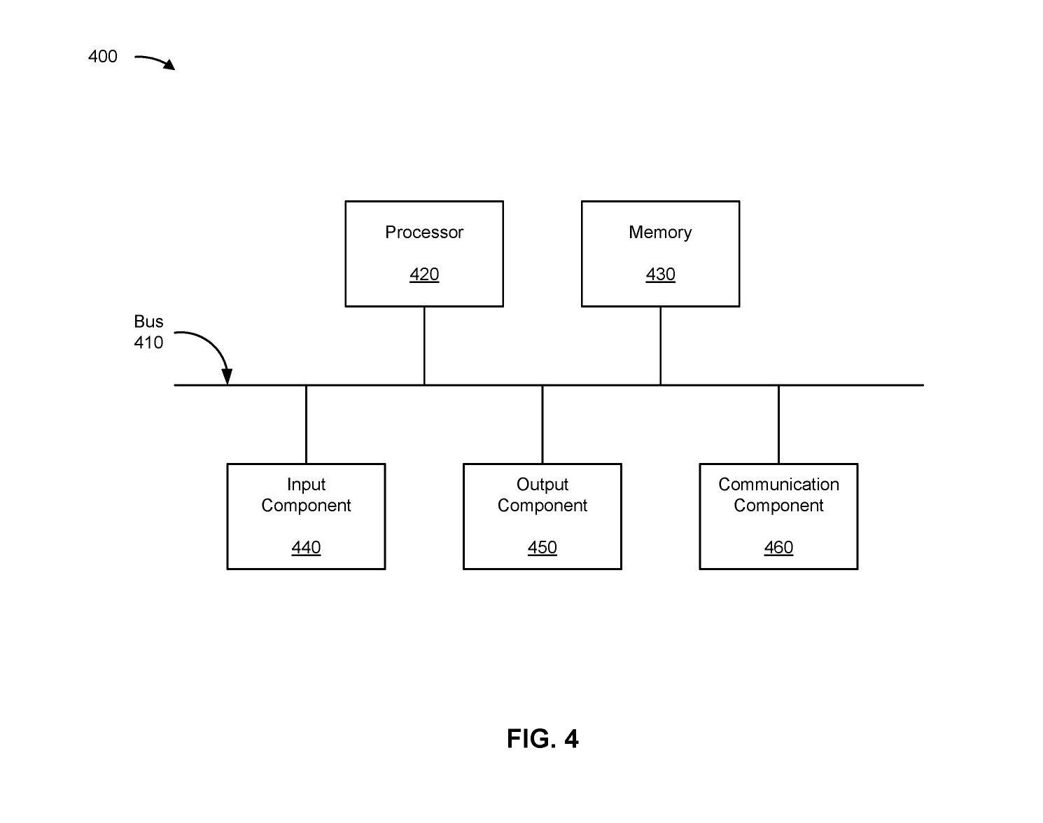

FIGS. 1A-1C are diagrams of an example 100 associated with automated audit response generation. As shown in FIGS. 1A-1C, example 100 includes a user device, a response system, and a storage system. These devices are described in more detail in connection with FIGS. 3 and 4.

As shown in FIG. 1A and by reference number 110, the user device may transmit, and the response system may receive, a file (e.g., at least one file) encoding an audit request. The audit request may be represented by a first set of text in the file. Accordingly, the file encoding the audit request may include a word processing document (e.g., a Microsoft® Word document or an OpenOffice® document, among other examples) and/or a portable document format (pdf) document.

In one example, the file may be included in a request message (e.g., a hypertext transfer protocol (HTTP) message and/or a file transfer protocol (FTP) message, among other examples). Accordingly, the user device may navigate (e.g., using a web browser or another type of application executed by the user device) to a webpage controlled and/or hosted by (or at least associated with) the response system (and thus with an LLM provided by the response system). A user of the user device may interact with a user interface (UI) representing the webpage (and output via an output component of the user device) in order to trigger the user device to transmit the request message. The request message may therefore be a web request transmitted based on the webpage. In some implementations, input from the user of the user device may indicate the file, encoding the audit request, to include in the request (e.g., as a header).

In another example, the file may be included as an argument in an application programming interface (API) call. Accordingly, the user of the user device may provide (e.g., via an input component of the user device) input via a UI or text-based input (e.g., to a shell or a command line, among other examples) that triggers the user device to perform the API call. In some implementations, the input may indicate the file, encoding the audit request, to include as an argument to the API call.

In another example, the file may be included as an attachment in an email message. Accordingly, the user of the user device may provide (e.g., via an input component of the user device) input that triggers the user device to transmit the email message (e.g., to an email address controlled by, or at least associated with, the response system). In some implementations, the input may indicate the file, encoding the audit request, to include as an attachment in the email message.

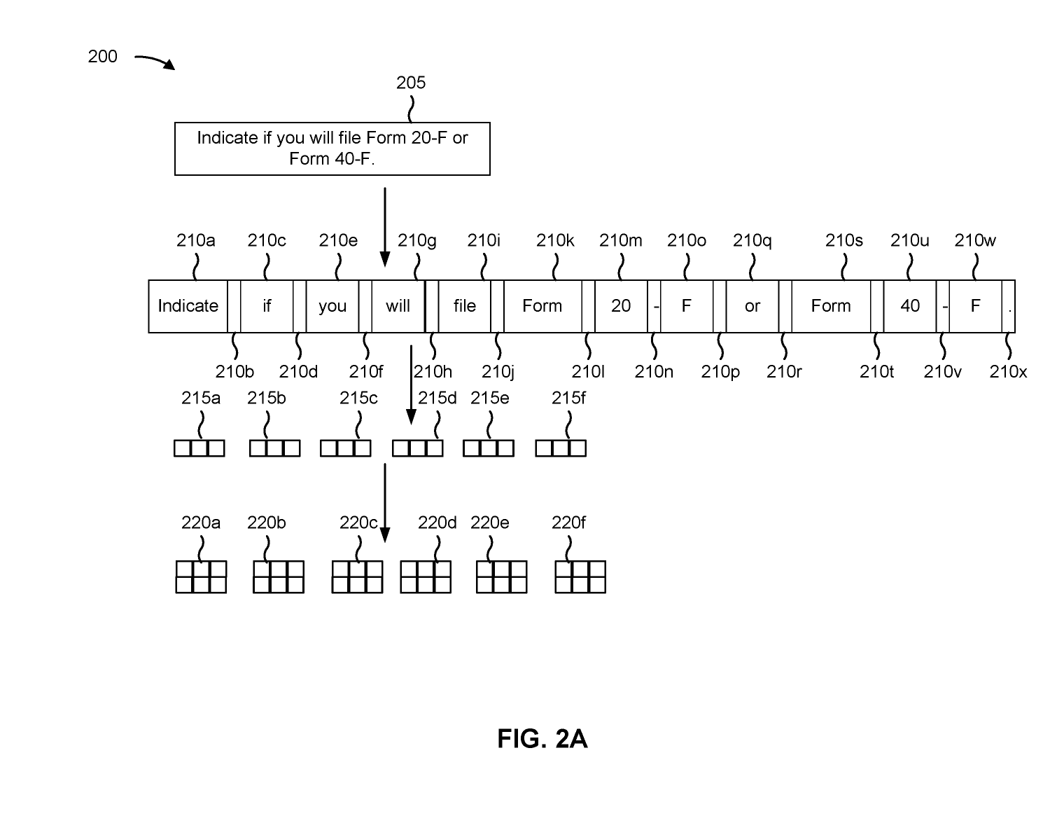

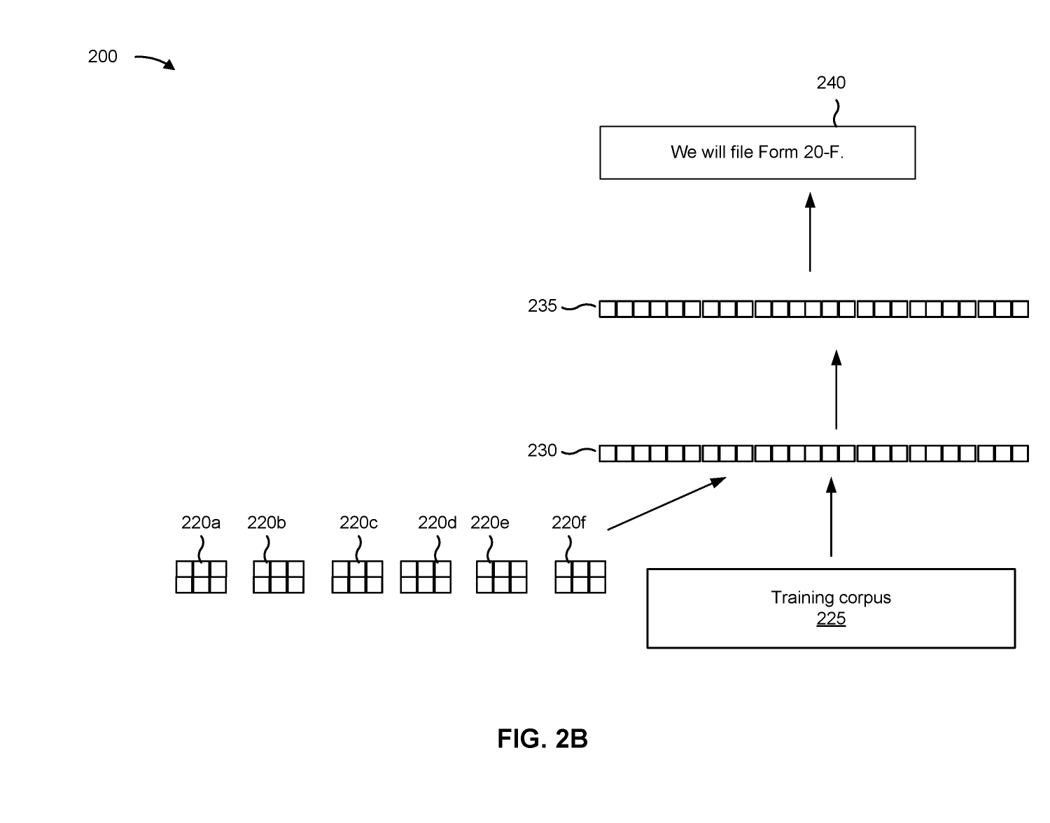

As shown by reference number 120, the response system may apply the LLM to the audit request in order to generate a draft response. Therefore, the response system may provide the first set of text (representing the audit request) to the LLM in order to receive a second set of text (representing the draft response). In some implementations, the LLM may process input and provide output as described in connection with FIGS. 2A-2B.

In one example, the response system may transmit, and a machine learning (ML) host associated with the LLM may receive, a request including the audit request (e.g., by including the first set of text representing the audit request). Accordingly, the ML host may apply the LLM in order to generate the second set of text. The ML host may transmit, and the response system may receive, a message, in response to the request, that includes the draft response (e.g., by including the second set of text representing the draft response).

In another example, the response system may use the LLM locally. Accordingly, the response system may provide the audit request directly to the LLM (e.g., by inputting the first set of text to the LLM) and may receive the draft response directly from the LLM (e.g., by receiving the second set of text as output from the LLM).

In order to apply the LLM to the audit request, the ML host and/or the response system may generate prompts to the LLM using the first set of text. In one example, the first set of text may include a name of a specific form or report as a keyword; therefore, the ML host and/or the response system may generate a prompt that causes the LLM to generate a sentence that the specific form or report is attached. In another example, the first set of text may include a name of an agency associated with the audit request; therefore, the ML host and/or the response system may generate a prompt that causes the LLM to generate sentences that acknowledge the agency’s statutory and/or regulatory goals.

The LLM may be trained (e.g., by the ML host or the response system) using a set of previous audit requests and a set of previous responses. For example, a training corpus for the LLM (e.g., as described in connection with FIG. 2B) may include text included in the previous audit requests and the previous responses. In some implementations, the ML host and/or the response system may identify a set of outcomes corresponding to the set of previous audit requests; therefore, the LLM may be further trained using the set of outcomes. For example, text included in previous audit requests and previous responses associated with positive outcomes may be prioritized over text included in previous audit requests and previous responses associated with negative outcomes.

As shown in FIG. 1B and by reference number 130, the response system may map (at least a portion of) the second set of text (representing the draft response) to a set of supporting documents. For example, the set of supporting documents may be stored and indexed in the storage system, which is accessible by the response system. In some implementations, the set of supporting documents are indexed according to keywords. For example, “keywords” may exclude common words (such as conjunctions, articles, and prepositions, among other examples) and/or may be included on a list of important words (e.g., provided by an administrator or determined by an ML model separate from the LLM). Therefore, the response system may match keywords included in the second set of text to keywords used to index to the set of supporting documents.

Additionally, or alternatively, the response system may apply an ML model (separate from the LLM) to the draft response in order to determine the set of supporting documents. Therefore, the response system may provide the second set of text (representing the draft response) to the ML model in order to receive an indication of the set of supporting documents. In some implementations, the ML model may include a linear regression model, an artificial neural network (ANN), a random forest model, and/or another type of ML model.

The ML model may be trained (e.g., by a same ML host that provides the LLM, by a different ML host, or by the response system) using keywords used to index the set of supporting documents. Accordingly, the ML model may determine which supporting documents are most relevant for the draft response (e.g., using relevance scores and/or another type of quantitative output from the ML model). Because the ML model is more lightweight than the LLM, the ML model may reduce computational cost and improve accuracy by avoiding risk of hallucinating supporting documents.

Additionally, or alternatively, the response system may receive the indication of the set of supporting documents from the LLM (in addition to receiving the draft response). In some implementations, the ML host may transmit, and the response system may receive, the indication along with the draft response (e.g., along with the second set of text representing the draft response). Alternatively, the response system may receive the indication directly from the LLM.

As shown in FIG. 1C and by reference number 140, the response system may generate a file (e.g., at least one file) encoding the draft response. For example, the response system may select a template (e.g., based on an agency associated with the audit request) and may insert the second set of text into the template in order to generate the file. The template may be a word processing document, associated with the agency, that includes a plurality of indicators. The plurality of indicators may correspond to different portions of the draft response (e.g., different portions of the second set of text). Accordingly, the response system may map different portions of the second set of text to different indications included in the template. The indicators may include placeholder texts, fields, and/or indices, among other examples.

Using the template allows the LLM to ignore formatting (because the template will handle formatting). As a result, the response system conserves computing resources as compared with trying to prompt the LLM to engage in proper formatting.

As shown by reference number 150, the response system may output, and the user device may receive, the file encoding the draft response. For example, the response system may transmit, and the user device may receive, the file encoding the draft response in response to the file encoding the audit request. Therefore, the user device may receive the second set of text (representing the draft response) that was provided by the LLM based on the first set of text (representing the audit request). The file encoding the draft response may be a word processing document or a pdf document.

Additionally, as shown by reference number 160, the response system may output, and the user device may receive, the indication of the set of supporting documents. For example, the response system may transmit, and the user device may receive, the indication in response to the file encoding the audit request. The set of supporting documents may be stored in the storage system, which may be accessible by the user device.

In one example, the indication may include one or more names associated with the set of supporting documents. Accordingly, the user device may use the name(s) to access the set of supporting documents from the storage system. In another example, the indication may include one or more filepaths usable by the storage system. Accordingly, the user device may request the set of supporting documents from the storage system using the filepath(s).

In some implementations, the user device may transmit, and the response system may receive, feedback associated with the file encoding the draft response, as shown by reference number 170. For example, the feedback may include qualitative feedback (e.g., a score or a letter grade, among other example) and/or quantitative feedback (e.g., text representing the feedback). In some implementations, (at least a portion of) the feedback may be associated with the entire draft response. Additionally, or alternatively, (at least a portion of) the feedback may be associated with a particular portion of the draft response (e.g., a particular section as indicated by a heading, an index, or a pixel location, among other examples).

As shown by reference number 180, the response system may refine and/or retrain the LLM using the feedback. For example, the response system may provide the feedback to the ML host, and the ML host may refine and/or retrain the LLM. Alternatively, the response system may refine and/or retrain the LLM locally.

As indicated above, FIGS. 1A-1C are provided as an example. Other examples may differ from what is described with regard to FIGS. 1A-1C.

FIGS. 2A-2B are diagrams of an example 200 associated with applying an LLM. The example 200 depicts a process performed by an ML host executing the LLM (e.g., in response to an instruction from a response system). These devices are described in more detail in connection with FIGS. 3 and 4.

The LLM may include one or more encoding layers, each encoding layer with a self-attention layer and a feed-forward neural network. FIG. 2A depicts operations performed by an encoding layer.

An input 205 to the LLM may be a natural language sentence (e.g., from an audit request, as described in connection with FIG. 1A). The input may be transformed into a set of tokens 210 using a tokenization scheme. As shown in FIG. 2A, some tokens are for words (e.g., tokens 210a, 210c, 210e, 210g, 210i, 210k, 210q, and 210s), some tokens are for numbers or letters (e.g., tokens 210m, 210o, 210u, and 210w), and some tokens are for punctuation (e.g., tokens 210b, 210d, 210f, 210h, 210j, 210l, 210n, 210p, 210r, 210t, 210v, and 210x). The set of tokens 210 are transformed into a set of vectors 215 using an embedding space. Some tokens may be discarded, such that the set of vectors 215 is smaller than the set of tokens (e.g., vectors 215a, 215b, 215c, 215d, 215e, and 215f are generated from the larger set of tokens). Accordingly, the tokenization scheme and the embedding space may be selected to increase accuracy (e.g., for a foundational model) or speed (e.g., for a rapid response model).

As shown in FIG. 2A, the set of vectors 215 may be transformed into a set of matrices 220. The set of matrices 220 may encode tokens as well as attention scores associated with the tokens. The attention scores mathematically represent relations between words in the input 205 (e.g., grammatical and logical relations).

The LLM may further include one or more decoding layers, each decoding layer with a self-attention layer, an attention layer, and a feed-forward neural network. FIG. 2B depicts operations performed by a decoding layer. The set of matrices 220 from the encoding layer(s) may be transformed into a score vector 230. A size of the score vector 230 may be determined by a size of a training corpus 225 for the LLM. Accordingly, the training corpus 225 may be selected to increase accuracy (e.g., by increasing output vocabulary) or speed (e.g., by limited output vocabulary and thus limiting the size of the score vector 230).

The score vector 230 may be transformed into a probability vector 235 (e.g., using a probability function and/or a normalization function). The probability vector 235 may indicate a subsequent word to include in output from the LLM. Accordingly, an output sentence 240 may be constructed one word at a time using the decoding layer(s).

As indicated above, FIGS. 2A-2B are provided as an example. Other examples may differ from what is described with regard to FIGS. 2A-2B.

FIG. 3 is a diagram of an example environment 300 in which systems and/or methods described herein may be implemented. As shown in FIG. 3, environment 300 may include a response system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an ML host 340, and/or a storage system 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the response system 301 may include one or more elements 303-312 of the cloud computing system 302, may execute within the cloud computing system 302, and/or may be hosted within the cloud computing system 302, in some implementations, the response system 301 may not be cloud-based (e.g., may be implemented outside of a cloud computing system) or may be partially cloud-based. For example, the response system 301 may include one or more devices that are not part of the cloud computing system 302, such as device 400 of FIG. 4, which may include a standalone server or another type of computing device. The response system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with audit requests, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The ML host 340 may include one or more devices capable of receiving, generating, storing, processing, providing, and/or routing information associated with machine learning models, as described elsewhere herein. The ML host 340 may include a communication device and/or a computing device. For example, the ML host 340 may include a server, such as an application server, a client server, a web server, a database server, a host server, a proxy server, a virtual server (e.g., executing on computing hardware), or a server in a cloud computing system. In some implementations, the ML host 340 may include computing hardware used in a cloud computing environment, such as one or more serverless components (e.g., one or more serverless functions). The ML host 340 may communicate with one or more other devices of environment 300, as described elsewhere herein.

The storage system 350 may include one or more devices capable of receiving, generating, storing, processing, and/or providing information associated with supporting documents, as described elsewhere herein. The storage system 350 may include a communication device and/or a computing device. For example, the storage system 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The storage system 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with automated audit response generation. The device 400 may correspond to a user device 330, an ML host 340, and/or a storage system 350. In some implementations, a user device 330, an ML host 340, and/or a storage system 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

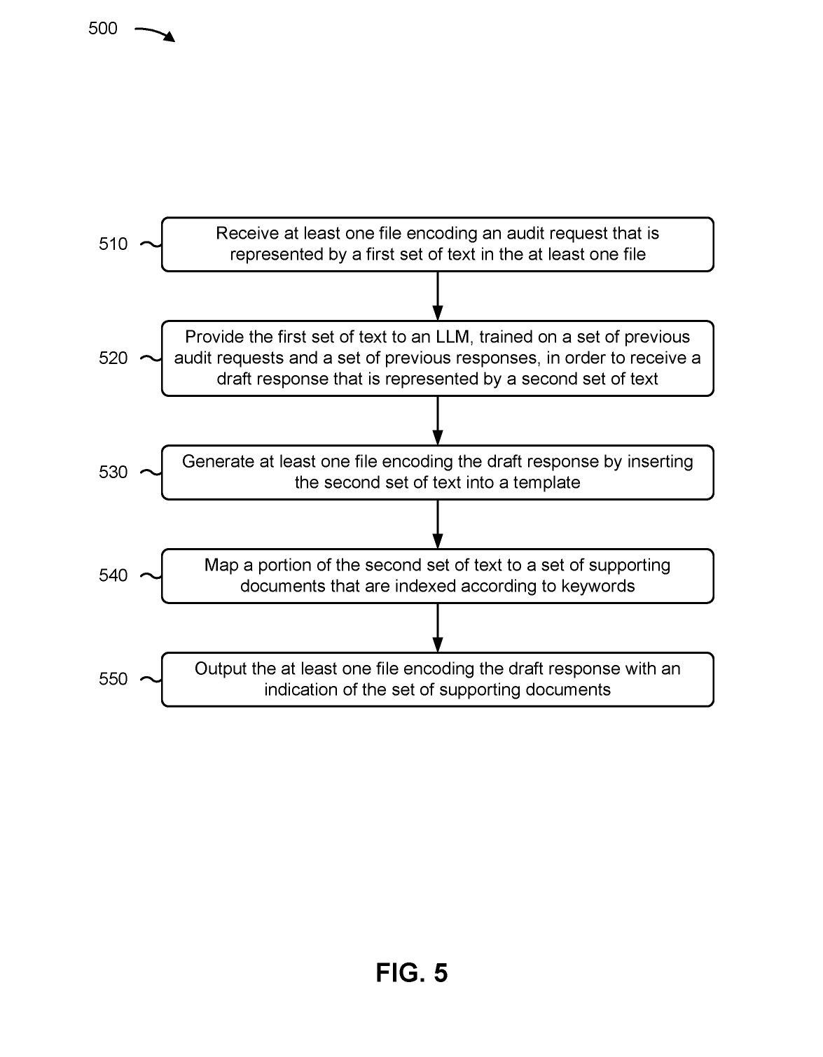

FIG. 5 is a flowchart of an example process 500 associated with automated audit response generation. In some implementations, one or more process blocks of FIG. 5 may be performed by a response system 301. In some implementations, one or more process blocks of FIG. 5 may be performed by another device or a group of devices separate from or including the response system 301, such as a user device 330, an ML host 340, and/or a storage system 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving at least one file encoding an audit request that is represented by a first set of text in the at least one file (block 510). For example, the response system 301 (e.g., using processor 420, memory 430, input component 440, and/or communication component 460) may receive at least one file encoding an audit request that is represented by a first set of text in the at least one file, as described above in connection with reference number 110 of FIG. 1A. As an example, the at least one file may be included in a request message (e.g., an HTTP message and/or an FTP message, among other examples). In another example, the at least one file may be included as an argument in an API call. In another example, the at least one file may be included as an attachment in an email message.

As further shown in FIG. 5, process 500 may include providing the first set of text to an LLM, trained on a set of previous audit requests and a set of previous responses, in order to receive a draft response that is represented by a second set of text (block 520). For example, the response system 301 (e.g., using processor 420, memory 430, and/or communication component 460) may provide the first set of text to an LLM, trained on a set of previous audit requests and a set of previous responses, in order to receive a draft response that is represented by a second set of text, as described above in connection with reference number 120 of FIG. 1A. As an example, the LLM may process input and provide output as described in connection with FIGS. 2A-2B. The response system 301 may apply the LLM locally or via an ML host associated with the LLM.

As further shown in FIG. 5, process 500 may include generating at least one file encoding the draft response by inserting the second set of text into a template (block 530). For example, the response system 301 (e.g., using processor 420 and/or memory 430) may generate at least one file encoding the draft response by inserting the second set of text into a template, as described above in connection with reference number 140 of FIG. 1C. As an example, the response system 301 may map different portions of the second set of text to different indications included in the template.

As further shown in FIG. 5, process 500 may include mapping a portion of the second set of text to a set of supporting documents that are indexed according to keywords (block 540). For example, the response system 301 (e.g., using processor 420, memory 430, and/or communication component 460) may map a portion of the second set of text to aa set of supporting documents that are indexed according to keywords, as described above in connection with reference number 130 of FIG. 1C. As an example, the response system 301 may match keywords included in the second set of text to keywords used to index to the set of supporting documents.

As further shown in FIG. 5, process 500 may include outputting the at least one file encoding the draft response with an indication of the set of supporting documents (block 550). For example, the response system 301 (e.g., using processor 420, memory 430, output component 450, and/or communication component 460) may output the at least one file encoding the draft response with an indication of the set of supporting documents, as described above in connection with reference numbers 150 and 160 of FIG. 1C. As an example, the response system 301 may output the at least one file encoding the draft response, along with the indication of the set of supporting documents, in response to the at least one file encoding the audit request.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

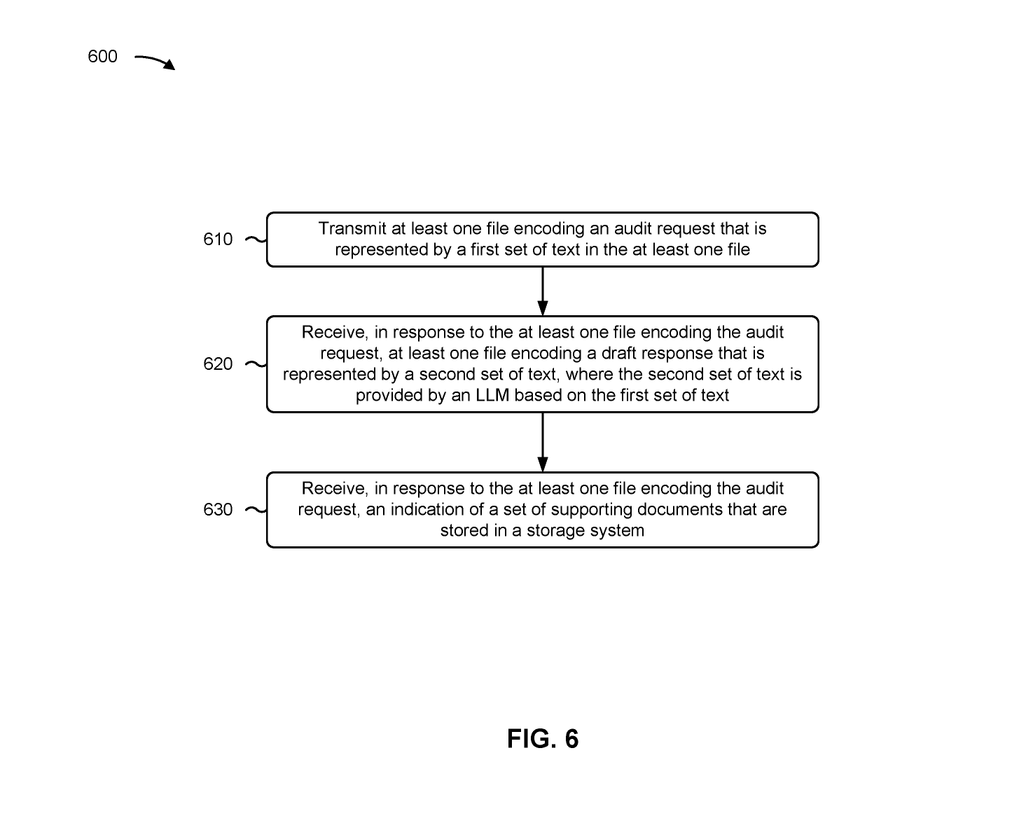

FIG. 6 is a flowchart of an example process 600 associated with automated audit response generation. In some implementations, one or more process blocks of FIG. 6 may be performed by a user device 330. In some implementations, one or more process blocks of FIG. 6 may be performed by another device or a group of devices separate from or including the user device 330, such as a user device 330, an ML host 340, and/or a storage system 350. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting at least one file encoding an audit request that is represented by a first set of text in the at least one file (block 610). For example, the user device 330 (e.g., using processor 420, memory 430, and/or communication component 460) may transmit at least one file encoding an audit request that is represented by a first set of text in the at least one file, as described above in connection with reference number 110 of FIG. 1A. As an example, a user of the user device 330 may provide (e.g., via input component 440) input via a UI or text-based input (e.g., to a shell or a command line, among other examples) that triggers the user device 330 to transmit the at least one file.

As further shown in FIG. 6, process 600 may include receiving, in response to the at least one file encoding the audit request, at least one file encoding a draft response that is represented by a second set of text, where the second set of text is provided by an LLM based on the first set of text (block 620). For example, the user device 330 (e.g., using processor 420, memory 430, and/or communication component 460) may receive, in response to the at least one file encoding the audit request, at least one file encoding a draft response that is represented by a second set of text, where the second set of text is provided by an LLM based on the first set of text, as described above in connection with reference number 150 of FIG. 1C. As an example, the at least one file encoding the draft response may include a word processing document or a pdf document.

As further shown in FIG. 6, process 600 may include receiving, in response to the at least one file encoding the audit request, an indication of a set of supporting documents that are stored in a storage system accessible by the device (block 630). For example, the user device 330 (e.g., using processor 420, memory 430, and/or communication component 460) may receive, in response to the at least one file encoding the audit request, an indication of a set of supporting documents that are stored in a storage system accessible by the device, as described above in connection with reference number 160 of FIG. 1C. As an example, the indication may include one or more names associated with the set of supporting documents and/or one or more filepaths usable by the storage system.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating a draft response and retrieving a set of supporting documents in response to an audit request, the system comprising:
one or more memories; and
one or more processors, communicatively coupled to the one or more memories, configured to:
receive at least one file encoding the audit request, wherein the audit request is represented by a first set of text in the at least one file;
provide the first set of text to a large language model (LLM), trained on a set of previous audit requests and a set of previous responses, in order to receive the draft response, wherein the draft response is represented by a second set of text;
generate at least one file encoding the draft response by inserting the second set of text into a template;
map a portion of the second set of text to the set of supporting documents, wherein the set of supporting documents are indexed according to keywords; and
output the at least one file encoding the draft response with an indication of the set of supporting documents.

2. The system of claim 1, wherein the one or more processors are configured to:
identify a set of outcomes corresponding to the set of previous audit requests,
wherein the LLM is further trained on the set of outcomes.

3. The system of claim 1, wherein the one or more processors are configured to:
select the template based on an agency associated with the audit request.

4. The system of claim 1, wherein the one or more processors, to map the portion of the second set of text to the set of supporting documents, are configured to:
match keywords included in the second set of text to the keywords used to index the set of supporting documents.

5. The system of claim 1, wherein the one or more processors, to map the portion of the second set of text to the set of supporting documents, are configured to:
provide the second set of text to a machine learning model, trained on the keywords used to index the set of supporting documents, in order to receive the indication of the set of supporting documents.

6. The system of claim 1, wherein the one or more processors, to map the portion of the second set of text to the set of supporting documents, are configured to:
receive the indication of the set of supporting documents from the LLM in addition to the draft response.

7. The system of claim 1, wherein the template comprises a word processing document with a plurality of indicators corresponding to different portions of the second set of text.

8. A method of generating a draft response based on an audit request, comprising:
receiving, from a user device and at a response system, at least one file encoding the audit request, wherein the audit request is represented by a first set of text in the at least one file;
providing the first set of text to a large language model (LLM), trained on a set of previous audit requests and previous responses, in order to receive the draft response, wherein the draft response is represented by a second set of text;
generating, by the response system, at least one file encoding the draft response by inserting the second set of text into a template; and
outputting, to the user device and from the response system, the at least one file encoding the draft response.

9. The method of claim 8, wherein the at least one file encoding the audit request comprises a word processing document or a portable document format document.

10. The method of claim 8, wherein generating the at least one file encoding the draft response comprises:
mapping different portions of the second set of text to different indicators included in the template.

11. The method of claim 8, wherein the at least one file encoding the draft response comprises a word processing document or a portable document format document.

12. The method of claim 8, further comprising:
receiving feedback associated with the at least one file encoding the draft response,
wherein the LLM is retrained or refined using the feedback.

13. The method of claim 8, wherein providing the first set of text to the LLM comprises:
transmitting, to a machine learning host associated with the LLM, a request including the first set of text; and
receiving, from the machine learning host and in response to the request, the draft response.

14. A non-transitory computer-readable medium storing a set of instructions for requesting a draft response and a set of supporting documents in response to an audit request, the set of instructions comprising:
one or more instructions that, when executed by one or more processors of a device, cause the device to:
transmit at least one file encoding the audit request, wherein the audit request is represented by a first set of text in the at least one file;
receive, in response to the at least one file encoding the audit request, at least one file encoding the draft response, wherein the draft response is represented by a second set of text, and wherein the second set of text is provided by a large language model (LLM) based on the first set of text; and
receive, in response to the at least one file encoding the audit request, an indication of the set of supporting documents, wherein the set of supporting documents are stored in a storage system accessible by the device.

15. The non-transitory computer-readable medium of claim 14, wherein the at least one file encoding the audit request is included in a request message.

16. The non-transitory computer-readable medium of claim 15, wherein the one or more instructions, when executed by the one or more processors, cause the device to:
navigate to a webpage associated with the LLM,
wherein the request message comprises a web request transmitted based on the webpage.

17. The non-transitory computer-readable medium of claim 14, wherein the one or more instructions, that cause the device to transmit the at least one file encoding the audit request, cause the device:
perform an application programming interface call including, as an argument, the at least one file encoding the audit request.

18. The non-transitory computer-readable medium of claim 14, wherein the one or more instructions, that cause the device to transmit the at least one file encoding the audit request, cause the device to:
transmit an email message including, as an attachment, the at least one file encoding the audit request.

19. The non-transitory computer-readable medium of claim 14, wherein the indication of the set of supporting documents comprises one or more names associated with the set of supporting documents.

20. The non-transitory computer-readable medium of claim 14, wherein the indication of the set of supporting documents comprises one or more filepaths usable by the storage system.
